(19) United States
(12) Patent Application Publication
(10) Pub. No.: US 2007/0268127 A1
(43) Pub. Date: Nov. 22, 2007

(54) WIRELESS SENSOR NODE DATA TRANSMISSION METHOD AND APPARATUS

(75) Inventors: Loren J. Rittle, Naperville, IL (US); Hongwei Zhang, Columbus, OH (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/419,531

(22) Filed: May 22, 2006

(51) Int. Cl. G08B 1/08; G08B 21/00

(52) U.S. Cl. 340/539.22; 340/870.16

(57) ABSTRACT

Generally speaking, pursuant to these various embodiments, a wireless sensor node (200) that is downstream of another wireless sensor node can provide (101) data as corresponds to a sensed condition and which is to be wirelessly transmitted upstream to a collection point via that other wireless sensor node and then determine (102) when to transmit that data as a function, at least in part, of data aggregation opportunities as may exist with respect to that other wireless sensor node. By one approach, a given data aggregation opportunity can comprise, for example, aggregating data regarding a plurality of temporally-differentiated sensed conditions and/or aggregating data from a plurality of wireless sensor nodes (such as, but not limited to, yet another wireless sensor node that is also downstream of the other wireless sensor node). By one optional approach, if desired, the wireless sensor node can determine when to transmit such data as a function of both data aggregation opportunities as are mentioned above as well as quality of service requirements as may otherwise pertain to the data. Relevant quality of service requirements might comprise, but are not limited to, a timeframe within which the data is to be provided to the upstream collection point.

### TECHNICAL FIELD

This invention relates generally to wireless sensor nodes and more particularly to the transmission of sensor data to an upstream collection point.

### BACKGROUND

Wireless sensor networks are known in the art. A plurality of wireless sensors may be distributed throughout a building, for example, to monitor various environmental circumstances of interest (such as temperature, humidity, proximal human activity, noise, motion, and essentially any other sensable condition that might occur proximal to such a sensor). In many cases at least some of these wireless sensors comprise stand-alone platforms having only limited power resources (such as a relatively small battery). Challenges often exist, therefore, to ensure timely provision of sensor data while also at least attempting to extend the useful operating life of the sensor platforms themselves.

Many wireless sensor network applications therefore have quality of service specifications that attempt to realize such a compromise. For example, a given application might require hourly temperature readings from a distributed set of wireless sensors. This requirement, in turn, can be utilized to schedule times during which the wireless sensors become active and transmit such data to a target collection point. In many instances, however, such attempts can become complicated due to other limitations that often characterize such wireless sensors.

For example, such platforms also often have a relatively limited transmission range. To illustrate, wireless sensors operating at 2.4 GHz and using IEEE 802.15.4 signaling protocols and in compliance with transmission power guidelines set forth by the United States Federal Communication Commission often have a maximum transmission range of only about 50 meters. To accommodate this situation many networks use a mesh-like solution to permit data to be moved upstream to a collection point via any number of intervening wireless sensors that essentially act as repeaters for downstream wireless sensors.

Unfortunately, such an approach tends to increase the number of transmission events that a given wireless sensor must support and will also typically increase the amount of total time that such a wireless sensor must remain in an active operational state. Both of these operational circumstances tend to accelerate power usage and hence contribute, sometimes greatly, to diminishing the operational lifetime of a given deployed wireless sensor.

### BRIEF DESCRIPTION OF THE DRAWINGS

The above needs are at least partially met through provision of the wireless sensor node data transmission method and apparatus described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a wireless sensor node that is downstream of another wireless sensor node can provide data as corresponds to a sensed condition and which is to be wirelessly transmitted upstream to a collection point via that other wireless sensor node and then determine when to transmit that data as a function, at least in part, of data aggregation opportunities as may exist with respect to that other wireless sensor node. By one approach, a given data aggregation opportunity can comprise, for example, aggregating data regarding a plurality of temporally-differentiated sensed conditions and/or aggregating data from a plurality of wireless sensor nodes (such as, but not limited to, yet another wireless sensor node that is also downstream of the other wireless sensor node).

By one optional approach, if desired, the wireless sensor node can determine when to transmit such data as a function of data aggregation opportunities as are mentioned above as well as quality of service requirements as may otherwise pertain to the data. Relevant quality of service requirements might comprise, but are not limited to, a timeframe within which the data is to be provided to the upstream collection point.

Information regarding data aggregation opportunities can be developed in any of a variety of ways depending upon the limitations and/or capabilities as characterize a given application setting. By one approach, for example, upstream wireless sensor nodes can transmit wireless messages to downstream wireless sensor nodes wherein the messages comprise, at least in part, data aggregation opportunity information.

So configured, sensor data (including but not limited to both locally developed and as may be received from downstream platforms) can be aggregated in an intelligent manner that tends to ensure both conservative use of a given wireless sensor node's transmission facilities and non-sleep time while also tending to ensure the timely delivery of sensor data to ensure that the needs of the governing application remain satisfied. These teachings are readily deployed using existing programmable sensor platforms and hence can be used in conjunction with already-deployed networks. Those skilled in the art will also appreciate that these teachings can be implemented at relatively low cost and can be administered with little additional overhead burden or expense.

These and other benefits may become clearer upon making a thorough review and study of the following detailed description. Referring now to the drawings, and in particular to FIG. 1, an illustrative process 100 for use in conjunction with a wireless sensor node will first be described. This wireless sensor node may be located downstream from a second wireless sensor node that is communicatively situated between the wireless sensor node and a target data collection point. By this process 100, the wireless sensor node provides 101 data as corresponds to a sensed condition of interest, which data is to be wirelessly transmitted upstream towards that collection point via that second wireless sensor node. The particulars regarding the sensed condition of interest and/or the acquisition of such data will of course vary from one application scenario to the next. As such particulars are generally well known in the art, and as these teachings are not particularly sensitive with respect to the selection of any particular choices in this regard, for the sake of brevity further elaboration regarding such points will not be presented here.

It may be noted, however, that such data may be locally obtained (and hence provided) at the wireless sensor node in accordance with some predetermined schedule. For example, it may be important in a given application setting that the data be so provided locally within a first predetermined period of time (such as, for example, once each hour). It may also be that the data as corresponds to a sensed condition is to be provided to the collection point within a second predetermined period of time (such as, for example, once each four hour period), which second period of time is of longer duration than the first predetermined period of time. Other similar examples are of course possible.

This process 100 then provides for determining 102 when to transmit that data to the second wireless sensor node as a function, at least in part, of data aggregation opportunities as may exist with respect to the second wireless sensor node. This can comprise, for example, aggregating data from a single wireless sensor node regarding a plurality of temporally-differentiated sensed conditions (such as, for purposes of illustration, a series of temperature readings that are taken at hourly intervals). This could also comprise, as another example, aggregating data from a plurality of wireless sensor nodes (such as, for purposes of illustration, a temperature reading taken at time X at a first wireless sensor node and another temperature reading taken at that same time X at a second, different wireless sensor node (such as another wireless sensor node that is also downstream of the first wireless sensor node)).

This determination step 102 can further comprise, if desired, determining when to transmit the data to the second wireless sensor node as a function, at least in part, of both the data aggregation opportunities criterion as noted above as well as quality of service requirements that may otherwise pertain to the data. Such an approach may be particularly helpful when the quality of service requirements relate, at least in part, to a timeframe within which the data is to be provided to a collection point that is upstream of the wireless sensor node. As one simple example, the wireless sensor node may be tasked with collecting a temperature reading on an hourly basis but the temporal quality of service requirements for the corresponding application require provision of such sensor data no later than four hours subsequent to its collection. In such a case, one can look for a most favorable data aggregation opportunity as may present itself within that four hour timeframe to thereby achieve both the benefits of data aggregation while also ensuring that an application's quality of service requirements remain met.

There are various ways by which this step of determining 102 when to transmit the data can be partially or fully informed and carried out. By one approach, this step can comprise, at least in part, receiving a wireless message from the upstream second wireless sensor node where that message comprises data aggregation opportunity information. Such information can comprise, for example, transmission schedule information, reception schedule information, available data buffer space, anticipated payload capacity, measured and/or expected best end-to-end delay of forwarded data through a particular upstream second wireless sensor node, membership status with respect to one or more functional groups as correspond to a particular upstream second wireless sensor node, a comparison as between a newly received message from an upstream second wireless sensor node against a similar report (or reports) as corresponds to a different, third wireless sensor node, and/or specific aggregation-based transmission instructions, to note but a few. Such a message can comprise a single transmission/reception event or can comprise a sequence of transmitted/received messages as may best suit the needs and/or opportunities of a given application setting. This can even comprise, for example, ignoring the actual contents of the most recently received message and using only the contents of one or more earlier received messages and the time of arrival of the most recently received message.

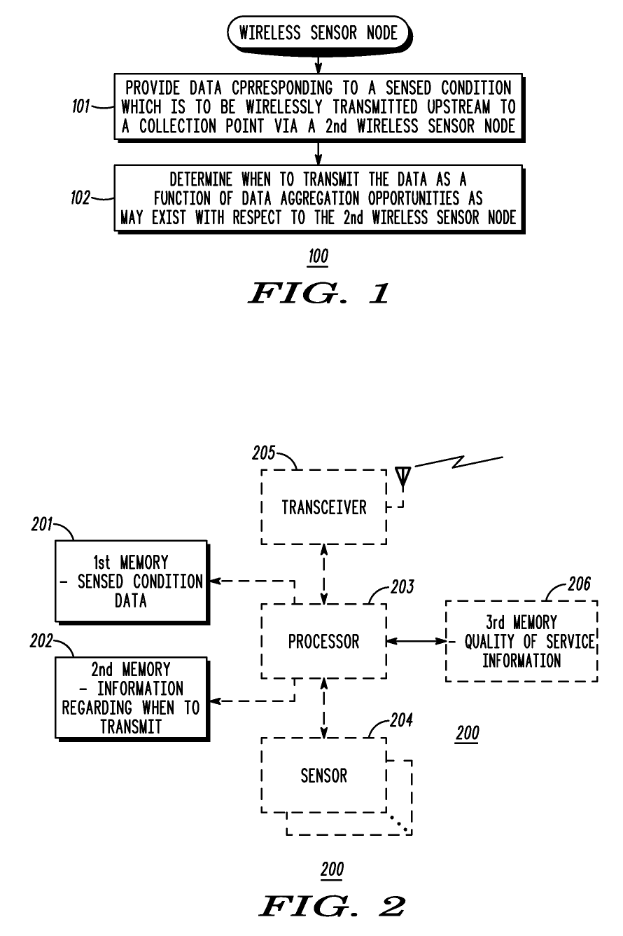

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative embodiment, a wireless sensor node 200 comprises a first memory 201 having data stored therein regarding a sensed condition, which data is to be wirelessly transmitted upstream towards a collection point via a second wireless sensor node and a second memory 202 having locally developed information stored therein regarding when to transmit the data to the second wireless sensor node to dynamically exploit a data aggregation opportunity as exists with respect to the second wireless sensor node. Such data can be provided and/or determined by application of the above-described process 100 if desired.

By one approach, this wireless sensor node 200 also comprises a processor 203 that operably couples to the first and second memory 201 and 202. This processor 203 may be configured and arranged, for example, to determine when to transmit the data to the second wireless sensor node as a function, at least in part, of data aggregation opportunities as may exist with respect to the second wireless sensor node. If desired, this processor 203 can also operably couple to at least a first sensor 204 (and possibly additional sensors as suggested by the illustration presented in FIG. 2). Such a configuration and architecture provides a mechanism by which the processor 203 can obtain the aforementioned data regarding a sensed condition. This configuration and architecture also permits such a processor 203 to then store such sensed condition data in the aforementioned first memory 201.

If desired, this wireless sensor node 200 may also comprise a transceiver 205 that operably couples to the processor 203. So configured, the transceiver 205 can serve as a receiver to facilitate and permit compatible reception of wireless messages from, for example, the upstream second wireless sensor node. Such wireless messages can comprise, for example, data aggregation opportunity information as has been previously described. Such a transceiver 205 can also serve as a suitable mechanism by which the sensed condition data is eventually transmitted by the wireless sensor node 200 to the upstream second wireless sensor node.

As described above, if desired, these teachings also provide for taking quality of service requirements into account when determining when to transmit the sensed condition data. To support such an approach, this illustrative embodiment also presents optional inclusion of a third memory 206 that is operably coupled to the processor 203 and that has stored therein information regarding such a quality of service as corresponds to provision of the data to the collection point. Such quality of service information can be relatively static or can, if desired, vary on a more dynamic basis depending upon the needs and requirements of a given application setting.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements (such as, but not limited to the various memories shown) can be enabled and realized via a shared platform. It will also be understood that such a shared platform may comprise a wholly or at least partially programmable platform as are known in the art.

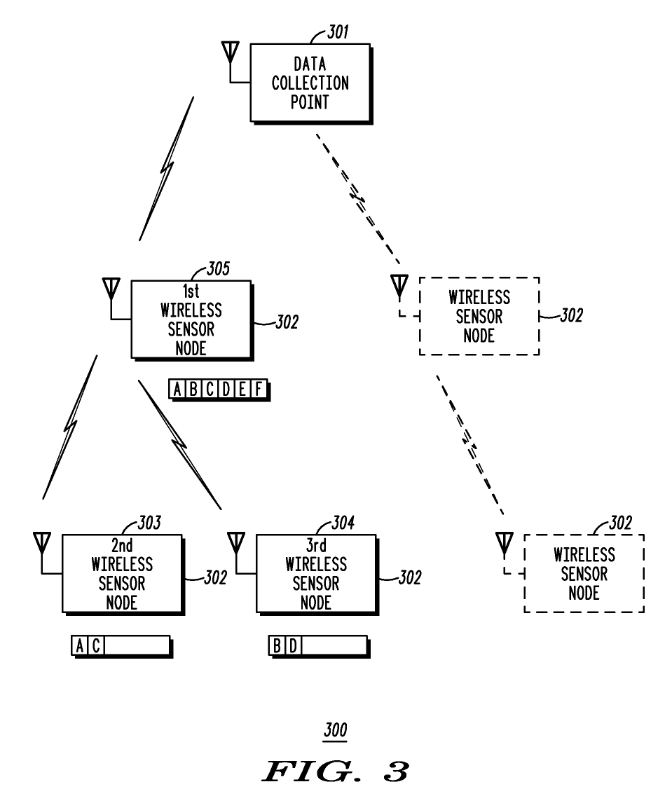

Referring now to FIG. 3, an illustrative example of these teachings in a given application and network setting will be provided. In this simple illustrative example, a given network 300 of wireless sensor nodes 302 are deployed in a distributed fashion throughout a building. A data collection point 301 (such as a suitably configured gateway node as is known in the art) serves to receive the sensor data from these various wireless sensor nodes. As noted earlier, the maximum transmission range of these wireless sensor nodes 302 is insufficient to ensure that the transmissions of some of these wireless sensor nodes 302 can directly reach the data collection point 301. For example, in this illustrative embodiment, a second and a third wireless sensor node 303 and 304 are unable to directly reach the data collection point 301. As per existing practice an intervening wireless sensor node 302 serves to receive and forward the data from such outlying platforms. In this particular illustrative embodiment, a first wireless sensor node 305 serves to receive the sensor data transmissions of the second and third wireless sensor nodes 303 and 304 and to forward that data onwards to the data collection point 301.

For purposes of this illustrative example, this network 300 supports an application that needs to receive hourly temperature readings from each of the wireless sensor nodes 302. For quality of service purposes, however, it is not necessary that these temperature readings be received at the data collection point 301 on a corresponding hourly basis. Instead, it is acceptable if such readings are provided within four hours of the data having first been sensed and acquired by each individual wireless sensor node 302.

Accordingly, at a first hour, the first wireless sensor node 305 takes a temperature reading E, the second wireless sensor node 303 takes a temperature reading A, and the third wireless sensor node 304 takes a temperature reading B. In typical ordinary practice, the second and third wireless sensor nodes 303 and 304 would forward their respective temperature readings A and B on to the first wireless sensor node 305 in relatively short order (accounting, of course, for some delay as may be introduced by a need to postpone such a transmission until the end of a current transceiver sleep cycle). By these teachings, however, the second and third wireless sensor nodes 303 and 304 instead consider whether any data aggregation opportunities exist with respect to the first wireless sensor node 305.

In this embodiment the first wireless sensor node 305 transmits a message to the second and third wireless sensor nodes 303 and 304 (using, for example, an already scheduled transmission opportunity) to inform the latter regarding its own buffer capacity and, for example, the number of downstream wireless sensor nodes 302 that it must serve. In this example, the second and third wireless sensor nodes 303 and 304 independently determine that they may defer transmitting their respective temperature readings A and B until they have additional data to transmit as the first wireless sensor node's capacity is sufficient to accommodate such an action and further because such an action will not lead to a violation of the temporal quality of service requirements of the application being served.

Accordingly, an hour later, these wireless sensor nodes 302 again capture a current temperature reading. The downstream wireless sensor nodes 303 and 304 can now determine to transmit that accumulated sensor data as the buffer capacity of the upstream wireless sensor node 305 will not accommodate further sensor data aggregation. Accordingly, the second wireless sensor node 303 transmits its temperature readings A and C while the third wireless sensor node 304 transmits its temperature readings B and D. The first wireless sensor node 305 then aggregates this received sensor reading information with its own temperature readings E and F and transmits that information on to the data collection point 301.

This simple illustration exemplifies that transmissions by the downstream wireless sensor nodes are reduced through dynamic use of aggregation opportunities while simultaneously, if desired, quality of service standards are relate to the gathering of the corresponding data remain satisfied. Those skilled in the art will recognize that this illustrative example represents only a non-exhaustive representation and that numerous other scenarios are both possible and likely.

So configured, sensor data (including but not limited to both locally developed and as may be received from downstream platforms) is dynamically aggregated in an intelligent manner that aids in ensuring conservative use of a given wireless sensor node's transmission facilities and non-sleep time while also aiding to ensure the timely delivery of sensor data to ensure that the needs of the governing application remain satisfied. These teachings are readily deployed using existing programmable sensor platforms and hence can be used in conjunction with already-deployed networks. Those skilled in the art will also appreciate that these teachings can be implemented at relatively low cost and can be administered with little additional overhead burden or expense.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, multiple data aggregation opportunities as may exist in a long series of intervening wireless sensor nodes can be taken into account if so desired.

We claim:

1. A method comprising:
at a wireless sensor node that is downstream from a second wireless sensor node:
providing data as corresponds to a sensed condition, which data is to be wirelessly transmitted upstream towards a collection point via the second wireless sensor node;
determining when to transmit the data to the second wireless sensor node as a function, at least in part, of data aggregation opportunities as may exist with respect to the second wireless sensor node.

2. The method of claim 1 wherein providing data comprises providing the data within a first predetermined period of time.

3. The method of claim 2 wherein providing data as corresponds to a sensed condition, which data is to be wirelessly transmitted upstream towards a collection point comprises providing data as corresponds to a sensed condition, which data is to be provided to the collection point within a second predetermined period of time, which second predetermined period of time is of longer duration than the first predetermined period of time.

4. The method of claim 1 wherein at least one of the data aggregation opportunities comprises aggregating data regarding a plurality of temporally-differentiated sensed conditions.

5. The method of claim 1 wherein at least one of the data aggregation opportunities comprises aggregating data from a plurality of wireless sensor nodes.

6. The method of claim 5 wherein at least one of the plurality of wireless sensor nodes comprises a third wireless sensor node that is downstream of the second wireless sensor mode and is other than the wireless sensor node.

7. The method of claim 1 wherein determining when to transmit the data to the second wireless sensor node as a function, at least in part, of data aggregation opportunities as may exist with respect to the second wireless sensor node further comprises determining when to transmit the data to the second wireless sensor node as a function, at least in part, of:
data aggregation opportunities as may exist with respect to the second wireless sensor node;
quality of service requirements as may otherwise pertain to the data.

8. The method of claim 7 wherein the quality of service requirements relate, at least in part, to a timeframe within which the data is to be provided to a collection point that is upstream of the second wireless sensor node.

9. The method of claim 1 wherein determining when to transmit the data to the second wireless sensor node as a function, at least in part, of data aggregation opportunities as may exist with respect to the second wireless sensor node comprises receiving a wireless message from the second wireless sensor node comprising data aggregation opportunity information.

10. The method of claim 9 wherein determining when to transmit the data to the second wireless sensor node as a function, at least in part, of data aggregation opportunities as may exist with respect to the second wireless sensor node further comprises at least one of:
using a most recently received wireless message from the second wireless sensor node;
using contents of at least one earlier received wireless message from the second wireless sensor node.

11. A wireless sensor node comprising:
a first memory having data stored therein regarding a sensed condition, which data is to be wirelessly transmitted upstream towards a collection point via a second wireless sensor node;
a second memory having locally developed information stored therein regarding when to transmit the data to the second wireless sensor node to dynamically exploit a data aggregation opportunity as exists with respect to the second wireless sensor node.

12. The wireless sensor node of claim 11 further comprising:
a processor that is operably coupled to the first memory and the second memory and that is configured and arranged to determine when to transmit the data to the second wireless sensor node as a function, at least in part, of data aggregation opportunities as may exist with respect to the second wireless sensor node.

13. The wireless sensor node of claim 12 wherein the processor comprises means for determining when to transmit the data to the second wireless sensor node as a function, at least in part, of data aggregation opportunities as may exist with respect to the second wireless sensor node.

14. The wireless sensor node of claim 12 further comprising:
a receiver operably coupled to the processor and being configured and arranged to receive a wireless message from the second wireless sensor node comprising data aggregation opportunity information.

15. The wireless sensor node of claim 12 further comprising:
a third memory that is operably coupled to the processor and having stored therein information regarding a quality of service as corresponds to provision of the data to the collection point;
and wherein the processor further configured and arranged to determine when to transmit the data to the second wireless sensor node as a function, at least in part, of:
data aggregation opportunities as may exist with respect to the second wireless sensor node; and
quality of service requirements as may otherwise pertain to the data.

16. A method comprising:
providing a plurality of wireless sensor nodes and a data collection point;
when a first wireless sensor node must wirelessly provide sensor data to the data collection point via at least one intermediary wireless sensor node:
determining at the first wireless sensor node that a data aggregation opportunity exists with respect to the intermediary wireless sensor node;
upon determining that the data aggregation opportunity exists, dynamically arranging at the first wireless sensor node for transmission of the data to the intermediary wireless sensor node in a manner that tends to exploit the data aggregation opportunity.

17. The method of claim 16 wherein dynamically arranging at the first wireless sensor node for transmission of the data to the intermediary wireless sensor node in a manner that tends to exploit the data aggregation opportunity further comprises dynamically arranging at the first wireless sensor node for transmission of the data to the intermediary wireless sensor node in a manner that:
tends to exploit the data aggregation opportunity; and
that tends to comply with quality of service requirements as relate to provision of the data to the data collection point.

18. The method of claim 16 further comprising:
transmitting data aggregation opportunity information from the intermediary wireless sensor node to the first wireless sensor node.

19. The method of claim 18 wherein determining at the first wireless sensor node that a data aggregation opportunity exists with respect to the intermediary wireless sensor node comprises determining at the first wireless sensor node that a data aggregation opportunity exists as a function, at least in part, of the data aggregation opportunity information.
